(19) United States
(12) Patent Application Publication
(10) Pub. No.: US 2026/0340875 A1
(43) Pub. Date: Oct. 29, 2026

(54) VEHICLE CAMERA EXTRINSIC PARAMETER CALIBRATION METHOD, DEVICE, AND STORAGE MEDIUM

(71) Applicant: CHONGQING CHANGAN TECHNOLOGY CO., LTD., Chongqing (CN)

(72) Inventors: Shuhui XIE, Chongqing (CN); Deze ZHANG, Chongqing (CN)

(73) Assignee: CHONGQING CHANGAN TECHNOLOGY CO., LTD., Chongqing (CN)

(21) Appl. No.: 19/710,629

(22) Filed: Jun. 17, 2026

Related U.S. Application Data
(63) Continuation of application No. PCT/CN2026/071744, filed on Jan. 9, 2026.

(30) Foreign Application Priority Data
Jan. 10, 2025 (CN) 202510042699.6

(51) Int. Cl. G06T 7/80; G06T 3/02; H04N 23/695

(52) U.S. Cl. CPC G06T 7/80; G06T 3/02; H04N 23/695; G06T 2207/30244; G06T 2207/30264

(57) ABSTRACT

A vehicle camera extrinsic parameter calibration method, a device, and a storage medium, including: acquiring a ground image, mapping key points of the ground image according to an image coordinate system to obtain image coordinates of the key points in the image coordinate system, and generating a grid; adjusting initial extrinsic parameters of the camera based on the image coordinates, and determining a translation vector, for controlling a first line of the grid to be parallel to a second line of a preset parking area; acquiring an intrinsic parameter matrix of the camera, and Euler angles between a camera coordinate system and a vehicle coordinate system, and generating an affine transformation matrix through the intrinsic parameter matrix, the translation vector, and the Euler angles; and converting the image coordinates to target coordinates through the affine transformation matrix, and performing extrinsic parameter calibration on the camera through the target coordinates.

### CROSS-REFERENCE TO RELATED APPLICATIONS

The present application is a continuation-application of International (PCT) Patent Application No. PCT/CN2026/071744, filed on Jan. 9, 2026, which claims priority to Chinese Patent Application No. 202510042699.6, filed on Jan. 10, 2025, titled “Vehicle Camera Extrinsic Parameter Calibration Method, Apparatus, Device, and Storage Medium”, the entire contents of which are incorporated herein by reference.

### TECHNICAL FIELD

The present disclosure relates to the technical field of image processing, and in particular, to a vehicle camera extrinsic parameter calibration method, a device, and a storage medium.

### BACKGROUND

With the development of intelligent driving technology, cameras are increasingly widely used in vehicles. Vehicles perceive the environment through cameras installed on the vehicle after calibrating their intrinsic and extrinsic parameters. Camera intrinsic and extrinsic parameters are important parameters describing the camera imaging model. They respectively describe the internal characteristics of the camera and the relationship between the camera and the external world. Among them, the intrinsic parameters refer to corresponding parameters from a camera coordinate system to an image coordinate system, while the extrinsic parameters refer to corresponding parameters from a world coordinate system to the camera coordinate system.

Currently, traditional camera extrinsic parameter calibration adopts a checkerboard as an image to obtain corner pixel coordinates in the image coordinate system and calculate the camera extrinsic parameters. However, because acquiring the corner pixel coordinates of the image coordinate system requires manual effort, the acquisition process may suffer from inaccuracies in the corner pixel coordinates, and the acquisition is difficult and inefficient, which further affects the efficiency of camera extrinsic parameter calculation.

### SUMMARY OF THE DISCLOSURE

A first aspect of the embodiments of the present disclosure provides a vehicle camera extrinsic parameter calibration method, the method including:
acquiring a ground image collected by the vehicle camera, mapping key points of the ground image according to an image coordinate system to obtain image coordinates of the key points in the image coordinate system, and generating a grid through the image coordinates of the key points;
adjusting initial extrinsic parameters of the vehicle camera based on the image coordinates, and determining a translation vector of the vehicle camera; wherein the initial extrinsic parameters of the vehicle camera is adjusted to control a first line of the grid to be substantially parallel to a second line of a preset parking area;
acquiring an intrinsic parameter matrix of the vehicle camera, and Euler angles between a camera coordinate system and a vehicle coordinate system, and generating an affine transformation matrix through the intrinsic parameter matrix, the translation vector, and the Euler angles; and
converting the image coordinates to target coordinates through the affine transformation matrix, and performing extrinsic parameter calibration on the vehicle camera through the target coordinates.

A second aspect of the embodiments of the present disclosure provides an electronic device, including a processor, a memory, and a computer program stored on the memory and executable on the processor, wherein the computer program, when executed by the processor, implements the vehicle camera extrinsic parameter calibration method according to the first aspect of the embodiments of the present disclosure.

A third aspect of the embodiments of the present disclosure provides a readable storage medium, having a computer program stored thereon, wherein the computer program, when executed by a processor, implements the vehicle camera extrinsic parameter calibration method according to the first aspect of the embodiments of the present disclosure.

### BRIEF DESCRIPTION OF THE DRAWINGS

To describe the technical solutions in the embodiments of the present disclosure or in the related art more clearly, the following briefly introduces the accompanying drawings required for describing the embodiments. Apparently, the accompanying drawings in the following description show merely some embodiments of the present disclosure, and those skilled in the art may derive other drawings from these accompanying drawings without creative efforts.

FIG. 1 is a flowchart of a vehicle camera extrinsic parameter calibration method according to some embodiments of the present disclosure.

FIG. 2 is a flowchart of operation 101 of the vehicle camera extrinsic parameter calibration method according to the embodiments of the present disclosure in FIG. 1.

FIG. 3 is a flowchart of operation 102 of the vehicle camera extrinsic parameter calibration method according to the embodiments of the present disclosure in FIG. 1.

FIG. 4 is a flowchart of operation 103 of the vehicle camera extrinsic parameter calibration method according to the embodiments of the present disclosure in FIG. 1.

FIG. 5 is a flowchart of operation 104 of the vehicle camera extrinsic parameter calibration method according to the embodiments of the present disclosure in FIG. 1.

FIG. 6 is a schematic diagram of a scenario of the vehicle camera extrinsic parameter calibration method according to some embodiments of the present disclosure.

FIG. 7 is a flowchart of another vehicle camera extrinsic parameter calibration method according to some embodiments of the present disclosure.

FIG. 8 is a flowchart of further another vehicle camera extrinsic parameter calibration method according to some embodiments of the present disclosure.

FIG. 9 is a structural block diagram of a vehicle camera extrinsic parameter calibration apparatus according to some embodiments of the present disclosure.

FIG. 10 is a schematic structural diagram of an electronic device according to some embodiments of the present disclosure.

### DETAILED DESCRIPTION

The implementation manners of the present disclosure will be described below with reference to the accompanying drawings and embodiments. Those skilled in the art can easily understand other advantages and effects of the present disclosure from the content disclosed in this specification. The present disclosure may be implemented or applied through other different specific embodiments, and various details in this specification may be modified or changed based on different viewpoints and applications without departing from the spirit of the present disclosure. It should be understood that the embodiments are provided only for illustrating the present disclosure, and are not intended to limit the scope of the present disclosure.

Referring to FIG. 1, FIG. 1 is a flowchart of a vehicle camera extrinsic parameter calibration method according to some embodiments of the present disclosure. The method may include the following operations at blocks illustrated herein.

At block 101: A ground image collected by a vehicle camera is acquired, key points of the ground image are mapped according to an image coordinate system to obtain image coordinates of the key points in the image coordinate system, and a grid is generated through the image coordinates of the key points.

In the embodiments of the present disclosure, after a camera is installed on a vehicle, initial extrinsic parameters are calibrated. After the vehicle is used, the camera's extrinsic parameters are required to be recalibrated according to actual application scenarios. The instant embodiments are related to recalibrating the camera's extrinsic parameters after the vehicle is used. By processing the ground image captured by the camera, alignment between the ground image and an actual parking area is ensured. The lines of the parking area are combined with an affine transformation matrix to accurately convert points in the image coordinate system to the vehicle coordinate system, thereby simplifying the camera calibration process, reducing the complexity and error rate of manual operations, and improving the efficiency of camera extrinsic parameter calibration.

Specifically, intrinsic and extrinsic parameters correspond to the parameters of the camera mapped to different coordinate systems. The intrinsic parameters refer to parameters corresponding to the points from the camera coordinate system to the image. The extrinsic parameters refer to parameters corresponding to the points from the world coordinate system to the camera coordinate system. In the embodiments, the vehicle is located in a preset parking area. After ensuring the vehicle camera is aimed at the preset parking area, the processor first acquires the ground image collected by the vehicle camera, maps the key points of the ground image according to the image coordinate system to obtain the image coordinates of the key points in the image coordinate system, and generates a grid using the image coordinates of the key points.

It should be noted that the camera extrinsic parameters to be calibrated in the embodiments refer to the external parameters between the camera and the vehicle. The extrinsic parameters are configured in intelligent driving to cooperate with camera images to determine actual positions. The camera in the embodiments may be a camera capable of acquiring images, and may include a sensor. The camera may be installed inside or outside the vehicle and connected to an intelligent terminal. The intelligent terminal may be an in-vehicle computer, laptop, or other terminal device, which is not specifically limited here.

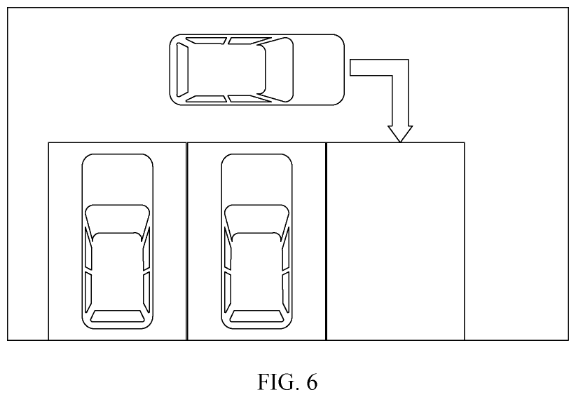

In the embodiments, referring to FIG. 6, FIG. 6 is a schematic diagram of a scenario of the vehicle camera extrinsic parameter calibration method according to some embodiments of the present disclosure. The vehicle camera may capture a ground image. The ground image may include ground information of a preset parking area. Key points may be boundary points or feature points of the parking area. The positions of the key points in the real world are required to be mapped to an image coordinate system. Here, the image coordinate system may take the top-left corner of the image as the origin, the horizontal rightward direction as the x-axis, and the vertical downward direction as the y-axis. The specific positions (x, y) coordinates of the key points in the image may be determined through image processing. The grid is a way of dividing the image for detailed analysis of the image content. Each key point corresponds to one or more cells in the grid. The grid helps to further analyze the shape and position of the parking area, ensuring the vehicle can accurately identify and locate the parking area.

At block 102: Initial extrinsic parameters of the camera are adjusted based on the image coordinates, and a translation vector of the camera is determined; where the initial extrinsic parameters of the camera are adjusted to control a first line of the grid to be parallel to a second line of a preset parking area.

In the embodiments of the present disclosure, based on the image coordinates of the key points, the initial extrinsic parameters of the camera are adjusted. Adjusting the initial extrinsic parameters of the camera is configured to control the first line of the grid to be parallel to the second line of the preset parking area, and the translation vector of the camera is determined. The purpose of making the first line of the grid parallel to the second line of the preset parking area is to ensure the vehicle body is parallel to the lane lines, facilitating the use of the principle that the parallelism of grid lines, which are virtually generated to be parallel to the parking area markings, remains unchanged after affine transformation through the camera model to adjust the extrinsic parameters.

In the embodiments, the processor may first acquire an initial position of the camera and a current angle between the first line of the grid and the second line of the preset parking area. The initial extrinsic parameters of the camera are adjusted based on the image coordinates to adjust the current angle to an angle value at which the first line of the grid is parallel to the second line of the preset parking area. A current position of the camera is acquired, and the translation vector of the camera is determined using the initial position and the current position.

It should be noted that the initial extrinsic parameters are initial parameters of the camera when installed on the vehicle. The camera's extrinsic parameters include a rotation matrix (R) and a translation vector (T), configured to describe the position and orientation of the camera relative to the world coordinate system. The rotation matrix represents the rotation angles of the camera relative to the world coordinate system, which is a 3×3 matrix containing three rotation angles (typically rotations around the x-axis, y-axis, and z-axis). Through the rotation matrix, points in the world coordinate system can be transformed to the camera coordinate system. The translation vector is the position of the camera in three-dimensional space, which is a 3×1 vector containing the translation amounts of the camera in the x, y, and z directions. Through the translation vector, points in the world coordinate system can be transformed to the camera coordinate system.

Specifically, to make the first line of the grid parallel to the second line of the preset parking area, the camera's extrinsic parameters are required to be adjusted. The camera's angle may be adjusted such that the lines in the captured image align with the lines of the actual parking area. To make the camera aim at the parking area, the camera's horizontal and vertical positions are required to be adjusted. By comparing the positional difference between the first line in the grid and the second line of the preset parking area, the translation vector that needs to be adjusted can be calculated. That is, by adjusting the camera's extrinsic parameters, ensuring the first line in the grid is parallel to the second line of the preset parking area, the translation vector to be adjusted is calculated.

At block 103: An intrinsic parameter matrix of the camera and Euler angles between a camera coordinate system and a vehicle coordinate system are acquired, and an affine transformation matrix is generated through the intrinsic parameter matrix, the translation vector, and the Euler angles.

In the embodiments of the present disclosure, to utilize the principle that the parallelism of grid lines, which are virtually generated to be parallel to the parking area markings, remains unchanged after affine transformation through the camera model to adjust extrinsic parameters, the affine transformation matrix is obtained by acquiring the camera's intrinsic parameter matrix, the Euler angles between the camera coordinate system and the vehicle coordinate system, and the translation vector. The affine transformation matrix is configured to transform points from the camera coordinate system to the vehicle coordinate system. It should be noted that affine transformation (or affine mapping) is a special case of perspective transformation. Affine transformation refers to the process in geometry where an image undergoes a linear transformation and a translation from one vector space to another. In the camera model, the process from 3D world coordinates to image coordinates is an affine transformation.

At block 104: The image coordinates are converted to target coordinates through the affine transformation matrix, and extrinsic parameter calibration is performed on the camera through the target coordinates.

In the embodiments of the present disclosure, coordinate transformation is performed on the image coordinates through the affine transformation matrix to obtain target coordinates in the vehicle coordinate system. The key points are connected according to the target coordinates to obtain connecting lines. The target extrinsic parameters of the camera are calculated using the connecting lines. The target extrinsic parameters include a rotation matrix R and a translation vector T, describing the position and orientation of the camera in the vehicle coordinate system. Based on the target extrinsic parameters, extrinsic parameter calibration is performed on the camera.

The vehicle camera extrinsic parameter calibration method according to the embodiments of the present disclosure includes: acquiring a ground image collected by a vehicle camera, mapping key points of the ground image according to an image coordinate system to obtain image coordinates of the key points in the image coordinate system, and generating a grid through the image coordinates of the key points; adjusting initial extrinsic parameters of the camera based on the image coordinates, and determining a translation vector of the camera, for controlling a first line of the grid to be parallel to a second line of a preset parking area; acquiring an intrinsic parameter matrix of the camera, and Euler angles between a camera coordinate system and a vehicle coordinate system, and generating an affine transformation matrix through the intrinsic parameter matrix, the translation vector, and the Euler angles; and converting the image coordinates to target coordinates through the affine transformation matrix, and performing extrinsic parameter calibration on the camera through the target coordinates. The embodiments of the present disclosure process the ground image captured by the camera to ensure alignment between the ground image and the actual parking area, accurately convert points in the image coordinate system to the vehicle coordinate system through the lines of the parking area combined with the affine transformation matrix. The extrinsic parameter calibration process for the vehicle camera does not require additional production and placement of checkerboards, thereby effectively reducing the environmental and site requirements for calibration work, achieving efficient and accurate camera extrinsic parameter calibration, simplifying the camera calibration process, reducing the complexity and error rate of manual operations, and improving the efficiency of camera extrinsic parameter calibration.

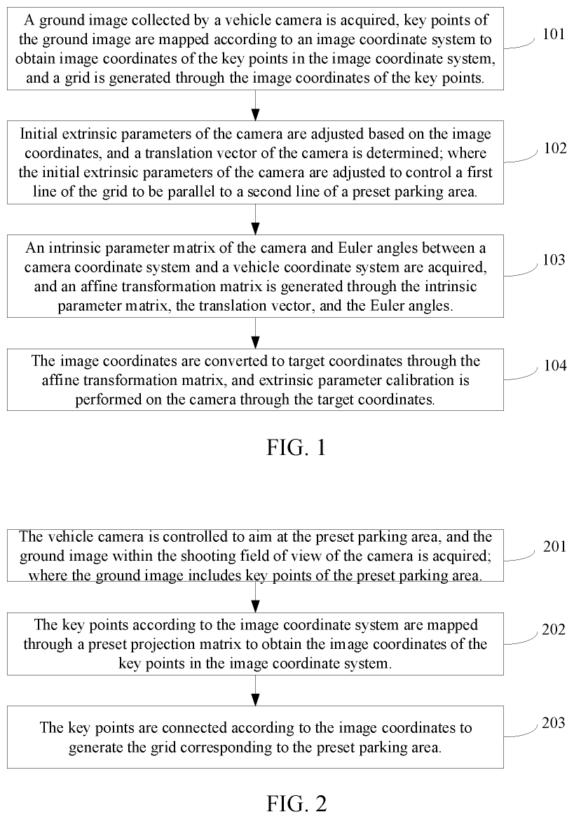

Further, referring to FIG. 2, FIG. 2 is a flowchart of operation 101 of the vehicle camera extrinsic parameter calibration method according to the embodiments of the present disclosure in FIG. 1. The operation 101 may specifically include the following operations at blocks illustrated herein.

At block 201: The vehicle camera is controlled to aim at the preset parking area, and the ground image within the shooting field of view of the camera is acquired; where the ground image includes key points of the preset parking area.

At block 202: The key points according to the image coordinate system are mapped through a preset projection matrix to obtain the image coordinates of the key points in the image coordinate system.

At block 203: The key points are connected according to the image coordinates to generate the grid corresponding to the preset parking area.

It should be noted that in the above operations, the vehicle camera is controlled to aim at the preset parking area, and the ground image within the camera's shooting field of view is acquired. Using the vehicle's control system, the camera's angle and position are adjusted to aim it at the preset parking area. The vehicle's sensors may serve to determine the vehicle's position and orientation, and adjust the camera accordingly. The camera captures the ground image of the parking area. The key points of the ground image are determined. The key points refer to the key points of the parking area, typically boundary points or feature points of the parking area. The key points are mapped to the image coordinate system through a preset projection matrix. The preset projection matrix is a combination of the camera's intrinsic parameter matrix and initial extrinsic parameter matrix, configured to map points from the real-world coordinate system to the image coordinate system. That is, the preset projection matrix is configured to transform the key points from the real-world coordinate system to the image coordinate system, obtaining the image coordinates of the key points. Based on the image coordinates of the key points, the key points are connected to form a grid. Each cell of the grid corresponds to a region in the image. The generation of the grid can be achieved by connecting lines with straight lines or more complex curve fitting. The generation of the grid helps to further analyze the shape and position of the parking area and provides precise visual information for autonomous driving or assisted driving systems.

The embodiment of the present disclosure may ensure that the camera can accurately capture the parking area and generates a grid corresponding to the key points. The vehicle may better utilize the parking area to determine camera parameters. The extrinsic parameter calibration process for the vehicle camera does not require making and placing checkerboards, thereby effectively reducing the environmental and site requirements for calibration work.

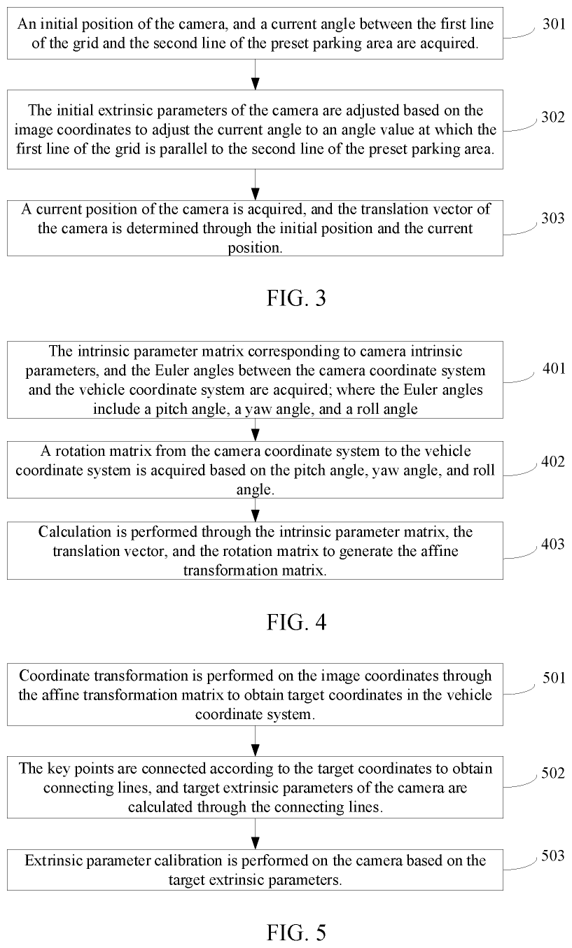

Further, referring to FIG. 3, FIG. 3 is a flowchart of operation 102 of the vehicle camera extrinsic parameter calibration method according to the embodiments of the present disclosure in FIG. 1. The operation 102 may specifically include the following operations at blocks illustrated herein.

At block 301: An initial position of the camera, and a current angle between the first line of the grid and the second line of the preset parking area are acquired.

At block 302: The initial extrinsic parameters of the camera are adjusted based on the image coordinates to adjust the current angle to an angle value at which the first line of the grid is parallel to the second line of the preset parking area.

At block 303: A current position of the camera is acquired, and the translation vector of the camera is determined through the initial position and the current position.

It should be noted that in the above operations, the initial position of the camera is usually provided by the vehicle's sensors. The initial position includes the camera's three-dimensional coordinates and initial orientation. The current angle between the first line of the grid and the second line of the preset parking area is determined. The current angle is the angle between the first line of the grid and the second line of the preset parking area. Based on the image coordinates, the initial extrinsic parameters of the camera are adjusted. The camera's initial extrinsic parameters include a rotation matrix (R) and a translation vector (T). The camera's rotation matrix R is adjusted based on the image coordinates such that the lines in the captured image align with the lines of the preset parking area. The current angle is adjusted such that the first line of the grid is parallel to the second line of the preset parking area. The current position of the camera is acquired. By comparing the initial position and the current position, the translation vector of the camera is calculated. The embodiments of the present disclosure, by adjusting the camera's position and angle, may ensure that the camera can accurately aim at the preset parking area, simplifies the parameter determination process with the help of the preset parking area for image processing.

Further, referring to FIG. 4, FIG. 4 is a flowchart of operation 103 of the vehicle camera extrinsic parameter calibration method according to the embodiments of the present disclosure in FIG. 1. The operation 103 may specifically include the following operations at blocks illustrated herein.

At block 401: The intrinsic parameter matrix corresponding to camera intrinsic parameters, and the Euler angles between the camera coordinate system and the vehicle coordinate system are acquired; where the Euler angles include a pitch angle, a yaw angle, and a roll angle.

At block 402: A rotation matrix from the camera coordinate system to the vehicle coordinate system is acquired based on the pitch angle, yaw angle, and roll angle.

At block 403: Calculation is performed through the intrinsic parameter matrix, the translation vector, and the rotation matrix to generate the affine transformation matrix.

It should be noted that in the above operations, the intrinsic parameter matrix corresponding to the camera intrinsic parameters and the Euler angles between the camera coordinate system and the vehicle coordinate system are acquired. Based on the pitch angle, yaw angle, and roll angle included in the Euler angles, matrix calculations are performed to obtain the rotation matrix from the camera coordinate system to the vehicle coordinate system. Matrix multiplication calculation is performed using the intrinsic parameter matrix, the translation vector, and the rotation matrix to generate the affine transformation matrix.

Specifically, the camera's intrinsic parameter matrix is acquired. The camera's intrinsic parameter matrix is usually denoted as K, containing focal length, principal point, and other internal parameters. fx and fy are the components of the focal length in the x and y directions (in pixels). cx and cy are the coordinates of the principal point in the image coordinate system. The Euler angles between the camera coordinate system and the vehicle coordinate system are acquired. The Euler angles describe the rotation of the camera coordinate system relative to the vehicle coordinate system. The Euler angles include roll angle, pitch angle, and yaw angle. Typically, three angles are used to represent rotations around the x-axis, y-axis, and z-axis respectively. Based on the pitch angle, yaw angle, and roll angle, the rotation matrix R from the camera coordinate system to the vehicle coordinate system is obtained. The translation vector is acquired. The translation vector describes the position of the camera in the vehicle coordinate system, usually denoted as T. The affine transformation matrix is configured to transform points from the image coordinate system to the vehicle coordinate system. The affine transformation matrix is usually denoted as M. The affine transformation matrix M is formed by combining the intrinsic parameter matrix K, the rotation matrix R, and the translation vector T. Through the affine transformation matrix M, points in the image coordinate system can be transformed to the vehicle coordinate system. Specifically, the affine transformation matrix M is as follows:

$$[ \begin{matrix}{f}_{x} & 0 & {c}_{x} & 0 \\ 0 & {f}_{y} & {c}_{y} & 0 \\ 0 & 0 & 1 & 0\end{matrix} ] [ \begin{matrix}{R}_{local 2 cam} & {T}_{3 \times 1} \\ {0}_{1 \times 3} & 1\end{matrix} ] [ \begin{matrix}{R}_{vcs 2 local} & {0}_{3 \times 1} \\ {0}_{1 \times 3} & 1\end{matrix} ] ;$$

where, R is the rotation matrix, T is the translation vector, fx and fy are the components of the focal length in the x and y directions, and cx and cy are the coordinates of the principal point in the image coordinate system. R_{local2cam} is the rotation matrix from the calibration coordinate system to the camera coordinate system, and R_{vcs2local} is the rotation matrix from the vehicle coordinate system to the calibration coordinate system.

Further, referring to FIG. 5, FIG. 5 is a flowchart of operation 104 of the vehicle camera extrinsic parameter calibration method according to the embodiments of the present disclosure in FIG. 1. The operation 104 may specifically include the following operations at blocks illustrated herein.

At block 501: Coordinate transformation is performed on the image coordinates through the affine transformation matrix to obtain target coordinates in the vehicle coordinate system.

At block 502: The key points are connected according to the target coordinates to obtain connecting lines, and target extrinsic parameters of the camera are calculated through the connecting lines.

At block 503: Extrinsic parameter calibration is performed on the camera based on the target extrinsic parameters.

It should be noted that in the above operations, the affine transformation matrix is acquired. Coordinate transformation is performed on the image coordinates through the affine transformation matrix to obtain target coordinates in the vehicle coordinate system. Coordinate transformation is performed on the image coordinates. Assuming a point in the image coordinate system is (x, y), it is transformed to a point (X, Y, Z) in the vehicle coordinate system. The affine transformation matrix M is used for transformation to obtain the target coordinates of the key points in the vehicle coordinate system. The key points are connected according to the target coordinates to obtain connecting lines. The connecting lines represent the boundaries or features of the parking area. Through the connecting lines, the target extrinsic parameters of the camera are calculated to ensure the connecting lines align with the boundaries of the actual parking area. The target extrinsic parameters include a rotation matrix R and a translation vector T, describing the position and orientation of the camera in the vehicle coordinate system. Using the target extrinsic parameters, the actual position and angle of the camera are adjusted to aim it at the preset parking area. Specifically, this may be achieved by adjusting the mechanical structure of the camera or the Electronic Control Unit (ECU), which is not specifically limited in the embodiments.

Specifically, the transformation relationship for converting a point (x, y) in the image coordinate system to a point (X, Y, Z) in the vehicle coordinate system is as follows:

$$[ \begin{matrix}x \\ y \\ 1\end{matrix} ] = [ \begin{matrix}{f}_{x} & 0 & {c}_{x} & 0 \\ 0 & {f}_{y} & {c}_{y} & 0 \\ 0 & 0 & 1 & 0\end{matrix} ] [ \begin{matrix}{R}_{local 2 cam} & {T}_{3 \times 1} \\ {0}_{1 \times 3} & 1\end{matrix} ] [ \begin{matrix}{R}_{vcs 2 local} & {0}_{3 \times 1} \\ {0}_{1 \times 3} & 1\end{matrix} ] [ \begin{matrix}X \\ Y \\ Z \\ 1\end{matrix} ] .$$

The embodiment of the present disclosure may ensure that the camera, with the help of the parking area, obtains the target extrinsic parameters of the camera through the affine transformation matrix and performs extrinsic parameter calibration. Using the lines of the parking area combined with the affine transformation matrix, points in the image coordinate system may be accurately converted to the vehicle coordinate system. The extrinsic parameter calibration process for the vehicle camera does not require additional production and placement of checkerboards, thereby achieving efficient and accurate camera extrinsic parameter calibration, simplifying the camera calibration process.

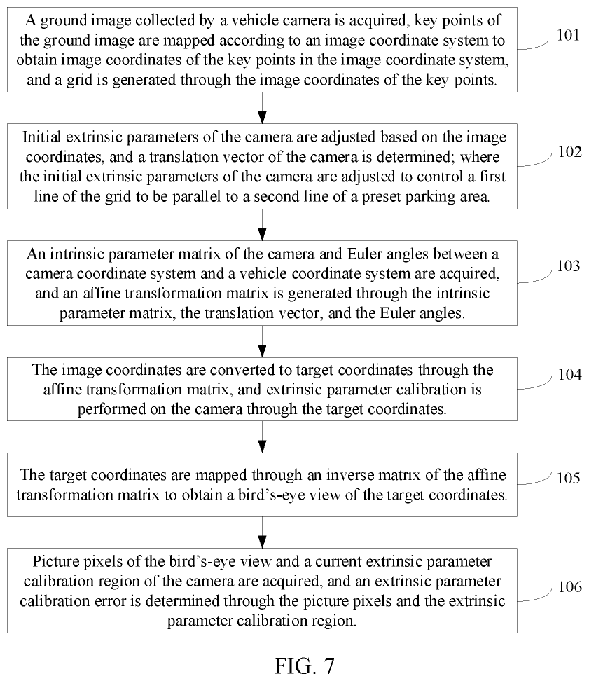

Referring to FIG. 7, FIG. 7 is a flowchart of another vehicle camera extrinsic parameter calibration method according to some embodiments of the present disclosure. The method may include the following operations at blocks illustrated herein.

At block 101: A ground image collected by a vehicle camera is acquired, key points of the ground image are mapped according to an image coordinate system to obtain image coordinates of the key points in the image coordinate system, and a grid is generated through the image coordinates of the key points.

At block 102: Initial extrinsic parameters of the camera are adjusted based on the image coordinates, and a translation vector of the camera is determined; where the initial extrinsic parameters of the camera are adjusted to control a first line of the grid to be parallel to a second line of a preset parking area.

At block 103: An intrinsic parameter matrix of the camera and Euler angles between a camera coordinate system and a vehicle coordinate system are acquired, and an affine transformation matrix is generated through the intrinsic parameter matrix, the translation vector, and the Euler angles.

At block 104: The image coordinates are converted to target coordinates through the affine transformation matrix, and extrinsic parameter calibration is performed on the camera through the target coordinates.

The operations 101 to 104 refer to the foregoing description and are not repeated here.

At block 105: The target coordinates are mapped through an inverse matrix of the affine transformation matrix to obtain a bird's-eye view of the target coordinates.

At block 106: Picture pixels of the bird's-eye view and a current extrinsic parameter calibration region of the camera are acquired, and an extrinsic parameter calibration error is determined through the picture pixels and the extrinsic parameter calibration region.

In the embodiments of the present disclosure, back-projection is used to map the key points back to the ground. Back-projection is configured to map points in the image back to the original scene. By using the inverse matrix of the affine transformation matrix, the key points in the image coordinate system are mapped back to ground coordinates, obtaining a bird's-eye view corresponding to the target coordinates of the key points. Through back-projection, points in the image are mapped back to ground coordinates, thereby generating a bird's-eye view. The bird's-eye view is a top-down view showing the ground layout of the parking area. When the generated bird's-eye view appears as a rectangle, it indicates good calibration conditions and correct camera extrinsic parameter settings.

Specifically, the picture pixels of the bird's-eye view and the current extrinsic parameter calibration region of the camera can be acquired, and the extrinsic parameter calibration error is determined using the picture pixels and the extrinsic parameter calibration region, verifying the error of the back-projection result. The vehicle is driven to the parking lot, ensuring the vehicle body is parallel to the lines of the parking space. A tape measure is used to measure the distance between the vehicle body and the parking space lines, ensuring the vehicle body is parallel to the parking space lines. The camera is activated to take a photo, causing the parking space to be within the field of view of the surround-view camera. The image from the surround-view camera is uploaded to a computer. When the perspective-projected top-down view appears as a rectangle, the calibration is successful.

Compared with the related art, in addition to achieving the beneficial effects brought by the above implementation manners, this implementation manner uses the principle of back-projection to map points back to the ground. Through the inverse matrix of the affine transformation matrix, points in the image coordinate system are mapped back to ground coordinates, obtaining a bird's-eye view, thereby verifying the calibration conditions. This may ensure that the camera can accurately capture the parking area and provides precise visual information for autonomous driving and assisted driving systems. By generating the bird's-eye view and verifying the error of the back-projection result, the vehicle may better understand and locate the parking area, thereby achieving automatic or semi-automatic parking functions.

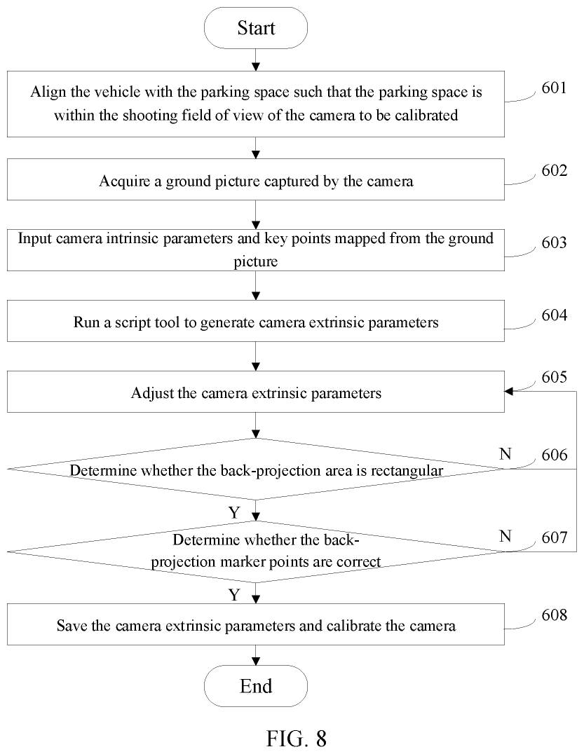

To enable those skilled in the art to more clearly understand the overall flow of the vehicle camera extrinsic parameter calibration method disclosed in the above implementation manners of the present disclosure, referring to FIG. 8, FIG. 8 is a flowchart of further another vehicle camera extrinsic parameter calibration method according to some embodiments of the present disclosure.

At block 601: Align the vehicle with the parking space such that the parking space is within the shooting field of view of the camera to be calibrated.

At block 602: Acquire a ground picture captured by the camera.

At block 603: Input camera intrinsic parameters and key points mapped from the ground picture.

At block 604: Run a script tool to generate camera extrinsic parameters.

At block 605: Adjust the camera extrinsic parameters.

At block 606: Determine whether the back-projection area is rectangular.

At block 607: Determine whether the back-projection marker points are correct.

At block 608: Save the camera extrinsic parameters and calibrate the camera.

In the embodiments of the present disclosure, the vehicle is aligned with the parking space such that the parking space is within the shooting field of view of the camera to be calibrated. The vehicle is driven to the parking space, ensuring the vehicle is parallel to the lines of the parking space. The camera's position and angle are adjusted such that it can capture the ground image of the parking area. The camera is activated to capture the ground image of the parking area. Camera intrinsic parameters are input. The camera's intrinsic parameter matrix contains focal length, principal point, and other internal parameters. Key points mapped from the ground picture are input. The key points are boundary points or feature points of the parking area. The positions of these key points in the image are determined. A pre-written script tool is used to generate camera extrinsic parameters (rotation matrix R and translation vector T) based on the input intrinsic parameter matrix and key points. The script tool typically uses nonlinear optimization algorithms (such as the Levenberg-Marquardt algorithm) to optimize the extrinsic parameters to minimize error. Based on the generated extrinsic parameters, the actual position and angle of the camera are adjusted to aim it at the preset parking area. Using the principle of back-projection, points in the image are mapped back to the ground coordinate system, generating a bird's-eye view. When the generated bird's-eye view appears as a rectangle, it indicates good calibration conditions, and the camera's intrinsic and extrinsic parameters are set correctly. Using the principle of back-projection, marker points in the image are mapped back to the ground coordinate system, obtaining ground point coordinates. The ground point coordinates are compared with actual measured values to calculate the error. When the error is within a preset range, it indicates the back-projection marker points are correct. The calibrated camera extrinsic parameters are saved to the system for subsequent image processing and analysis, completing the calibration process.

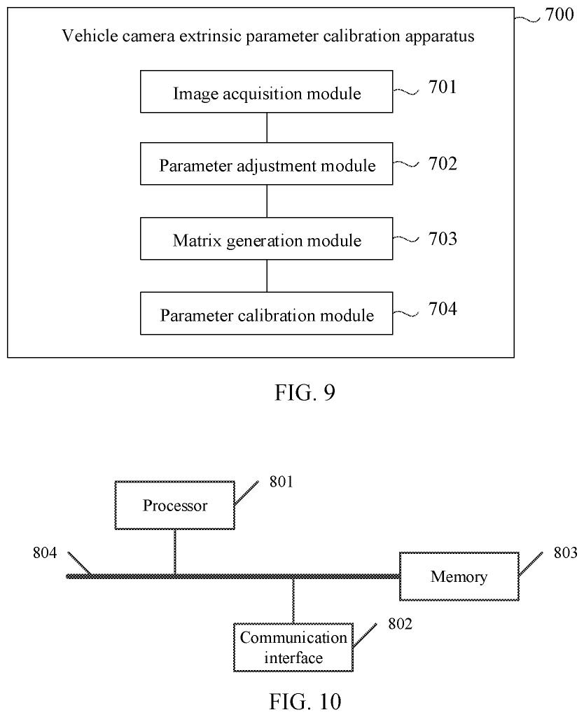

Referring to FIG. 9, FIG. 9 is a structural block diagram of a vehicle camera extrinsic parameter calibration apparatus 700 according to some embodiments of the present disclosure. The apparatus may include:
an image acquisition module 701, configured to acquire a ground image collected by a vehicle camera, map key points of the ground image according to an image coordinate system to obtain image coordinates of the key points in the image coordinate system, and generate a grid through the image coordinates of the key points;
a parameter adjustment module 702, configured to adjust initial extrinsic parameters of the camera based on the image coordinates, and determine a translation vector of the camera; where the initial extrinsic parameters of the camera is adjusted to control a first line of the grid to be parallel to a second line of a preset parking area;
a matrix generation module 703, configured to acquire an intrinsic parameter matrix of the camera, and Euler angles between a camera coordinate system and a vehicle coordinate system, and generate an affine transformation matrix through the intrinsic parameter matrix, the translation vector, and the Euler angles; and
a parameter calibration module 704, configured to convert the image coordinates to target coordinates through the affine transformation matrix, and perform extrinsic parameter calibration on the camera through the target coordinates.

In some embodiments, the image acquisition module 701 includes:
a first acquisition submodule, configured to control the vehicle camera to aim at the preset parking area, and acquire the ground image within the shooting field of view of the camera; where the ground image includes key points of the preset parking area;
a mapping submodule, configured to map the key points according to the image coordinate system through a preset projection matrix to obtain the image coordinates of the key points in the image coordinate system; and
a first generation submodule, configured to connect the key points according to the image coordinates to generate the grid corresponding to the preset parking area.

In some embodiments, the parameter adjustment module 702 includes:
a second acquisition submodule, configured to acquire an initial position of the camera, and a current angle between the first line of the grid and the second line of the preset parking area;
an adjustment submodule, configured to adjust the initial extrinsic parameters of the camera based on the image coordinates to adjust the current angle to an angle value at which the first line of the grid is parallel to the second line of the preset parking area; and
a determination submodule, configured to acquire a current position of the camera, and determine the translation vector of the camera through the initial position and the current position.

In some embodiments, the matrix generation module 703 includes:
a third acquisition submodule, configured to acquire the intrinsic parameter matrix corresponding to camera intrinsic parameters, and the Euler angles between the camera coordinate system and the vehicle coordinate system; where the Euler angles include a pitch angle, a yaw angle, and a roll angle;
a matrix submodule, configured to obtain a rotation matrix from the camera coordinate system to the vehicle coordinate system based on the pitch angle, the yaw angle, and the roll angle; and
a second generation submodule, configured to perform calculation using the intrinsic parameter matrix, the translation vector, and the rotation matrix to generate the affine transformation matrix.

In some embodiments, the parameter calibration module 704 includes:
a transformation submodule, configured to perform coordinate transformation on the image coordinates through the affine transformation matrix to obtain target coordinates in the vehicle coordinate system;
a calculation submodule, configured to connect the key points according to the target coordinates to obtain connecting lines, and calculate target extrinsic parameters of the camera through the connecting lines; and
a calibration submodule, configured to perform extrinsic parameter calibration on the camera based on the target extrinsic parameters.

In some embodiments, the apparatus further includes:
a coordinate processing module, configured to map the target coordinates through an inverse matrix of the affine transformation matrix to obtain a bird's-eye view of the target coordinates; and
an error determination module, configured to acquire picture pixels of the bird's-eye view and a current extrinsic parameter calibration region of the camera, and determine an extrinsic parameter calibration error through the picture pixels and the extrinsic parameter calibration region.

The vehicle camera extrinsic parameter calibration apparatus according to the embodiments of the present disclosure may perform: acquiring a ground image collected by a vehicle camera, mapping key points of the ground image according to an image coordinate system to obtain image coordinates of the key points in the image coordinate system, and generating a grid through the image coordinates of the key points; adjusting initial extrinsic parameters of the camera based on the image coordinates, and determining a translation vector of the camera, for controlling a first line of the grid to be parallel to a second line of a preset parking area; acquiring an intrinsic parameter matrix of the camera, and Euler angles between a camera coordinate system and a vehicle coordinate system, and generating an affine transformation matrix through the intrinsic parameter matrix, the translation vector, and the Euler angles; and converting the image coordinates to target coordinates through the affine transformation matrix, and performing extrinsic parameter calibration on the camera through the target coordinates. The embodiments of the present disclosure process the ground image captured by the camera to ensure alignment between the ground image and the actual parking area, accurately convert points in the image coordinate system to the vehicle coordinate system through the lines of the parking area combined with the affine transformation matrix. The extrinsic parameter calibration process for the vehicle camera does not require additional production and placement of checkerboards, thereby effectively reducing the environmental and site requirements for calibration work, achieving efficient and accurate camera extrinsic parameter calibration, simplifying the camera calibration process, reducing the complexity and error rate of manual operations, and improving the efficiency of camera extrinsic parameter calibration.

Referring to FIG. 10, some embodiments of the present disclosure further provide an electronic device. As shown in FIG. 10, the electronic device includes a processor 801, a communication interface 802, a memory 803, and a communication bus 804. The processor 801, the communication interface 802, and the memory 803 can communicate with each other through the communication bus 804.

The memory 803 is configured to store a computer program.

The processor 801 is configured to execute the program stored on the memory 803 to implement the following operations:
acquiring a ground image collected by a vehicle camera, mapping key points of the ground image according to an image coordinate system to obtain image coordinates of the key points in the image coordinate system, and generating a grid through the image coordinates of the key points;
adjusting initial extrinsic parameters of the camera based on the image coordinates, and determining a translation vector of the camera; where the initial extrinsic parameters of the camera is configured to control a first line of the grid to be parallel to a second line of a preset parking area;
acquiring an intrinsic parameter matrix of the camera, and Euler angles between a camera coordinate system and a vehicle coordinate system, and generating an affine transformation matrix through the intrinsic parameter matrix, the translation vector, and the Euler angles; and
converting the image coordinates to target coordinates through the affine transformation matrix, and performing extrinsic parameter calibration on the camera through the target coordinates.

The communication bus mentioned in the above terminal may be a Peripheral Component Interconnect (PCI) bus, an Extended Industry Standard Architecture (EISA) bus, or the like. The communication bus may be divided into an address bus, a data bus, a control bus, etc. For ease of representation, only one thick line is used in the figure, but it does not mean that there is only one bus or one type of bus.

The communication interface is configured for communication between the above terminal and other devices.

The memory may include a Random Access Memory (RAM), and may include a non-volatile memory, such as at least one magnetic disk storage device. In some embodiments, the memory may be at least one storage device located remotely from the aforementioned processor.

The aforementioned processor may be a general-purpose processor, including a Central Processing Unit (CPU), a Network Processor (NP), etc.; it may be a Digital Signal Processor (DSP), an Application Specific Integrated Circuit (ASIC), a Field-Programmable Gate Array (FPGA) or other programmable logic device, discrete gate or transistor logic device, discrete hardware component.

In yet other embodiments provided by the present disclosure, a computer-readable storage medium is provided. Instructions are stored in the computer-readable storage medium. When the instructions run on a computer, the computer is caused to execute the vehicle camera extrinsic parameter calibration method according to any one of the above embodiments.

In the above embodiments, implementation may be performed entirely or partially by software, hardware, firmware, or any combination thereof. When implemented by software, implementation may be performed entirely or partially in the form of a computer program product. The computer program product includes one or more computer instructions. When the computer program instructions are loaded and executed on a computer, the procedures or functions described in the embodiments of the present disclosure are generated entirely or partially. The computer may be a general-purpose computer, a special-purpose computer, a computer network, or other programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via wired (e.g., coaxial cable, optical fiber, Digital Subscriber Line (DSL)) or wireless (e.g., infrared, wireless, microwave, etc.) means. The computer-readable storage medium may be any available medium that can be accessed by a computer or a data storage device such as a server or data center integrated with one or more available media. The available medium may be a magnetic medium (e.g., floppy disk, hard disk, magnetic tape), an optical medium (e.g., DVD), or a semiconductor medium (e.g., Solid State Drive (SSD)), etc.

It should be noted that, in this document, relational terms such as first and second are used merely to distinguish one entity or operation from another entity or operation, and do not necessarily require or imply that there is any such actual relationship or order between these entities or operations. Moreover, the terms “comprising”, “including”, or any other variation thereof are intended to cover non-exclusive inclusion, such that a process, method, article, or device that includes a series of elements includes not only those elements but also other elements that are not explicitly listed, or also includes elements inherent to such process, method, article, or device. Without further limitation, an element defined by the phrase “comprising a . . . ” does not exclude the presence of additional identical elements in the process, method, article, or device that includes the element.

The various embodiments in this specification are described in a correlated manner, and identical or similar parts between the various embodiments may be referred to each other. Each embodiment focuses on the differences from other embodiments. In particular, for the system embodiment, since it is basically similar to the method embodiment, the description is relatively simple. For relevant parts, reference may be made to the partial description of the method embodiment.

The above descriptions are only some embodiments of the present disclosure and are not intended to limit the scope of the present disclosure. Any modifications, equivalent replacements, improvements, etc., made within the spirit and principles of the present disclosure shall be included within the scope of the present disclosure.

What is claimed is:

1. An extrinsic parameter calibration method for a vehicle camera, comprising:
acquiring a ground image collected by the vehicle camera, mapping key points of the ground image according to an image coordinate system to obtain image coordinates of the key points in the image coordinate system, and generating a grid through the image coordinates of the key points;
adjusting initial extrinsic parameters of the vehicle camera based on the image coordinates, and determining a translation vector of the vehicle camera; wherein the initial extrinsic parameters of the vehicle camera is adjusted to control a first line of the grid to be substantially parallel to a second line of a preset parking area;
acquiring an intrinsic parameter matrix of the vehicle camera, and Euler angles between a camera coordinate system and a vehicle coordinate system, and generating an affine transformation matrix through the intrinsic parameter matrix, the translation vector, and the Euler angles; and
converting the image coordinates to target coordinates through the affine transformation matrix, and performing extrinsic parameter calibration on the vehicle camera through the target coordinates.

2. The method according to claim 1, wherein the acquiring a ground image collected by the vehicle camera, mapping key points of the ground image according to an image coordinate system to obtain image coordinates of the key points in the image coordinate system, and the generating a grid through the image coordinates of the key points comprise:
controlling the vehicle camera to aim at the preset parking area, and acquiring the ground image within the shooting field of view of the vehicle camera; wherein the ground image comprises key points of the preset parking area;
mapping the key points of the preset parking area according to the image coordinate system through a preset projection matrix to obtain the image coordinates of the key points in the image coordinate system; and
connecting the key points of the preset parking area according to the image coordinates to generate the grid corresponding to the preset parking area.

3. The method according to claim 1, wherein the adjusting initial extrinsic parameters of the vehicle camera based on the image coordinates, and the determining a translation vector of the vehicle camera comprise:
acquiring an initial position of the vehicle camera, and a current angle between the first line of the grid and the second line of the preset parking area;
adjusting the initial extrinsic parameters of the vehicle camera based on the image coordinates to adjust the current angle to an angle value at which the first line of the grid is substantially parallel to the second line of the preset parking area; and
acquiring a current position of the vehicle camera, and determining the translation vector of the vehicle camera through the initial position and the current position.

4. The method according to claim 1, wherein the acquiring an intrinsic parameter matrix of the vehicle camera, and Euler angles between a camera coordinate system and a vehicle coordinate system, and the generating an affine transformation matrix through the intrinsic parameter matrix, the translation vector, and the Euler angles comprise:
acquiring the intrinsic parameter matrix corresponding to camera intrinsic parameters, and the Euler angles between the camera coordinate system and the vehicle coordinate system; wherein the Euler angles comprise a pitch angle, a yaw angle, and a roll angle;
obtaining a rotation matrix from the camera coordinate system to the vehicle coordinate system based on the pitch angle, yaw angle, and roll angle; and
performing calculation through the intrinsic parameter matrix, the translation vector, and the rotation matrix to generate the affine transformation matrix.

5. The method according to claim 1, wherein the converting the image coordinates to target coordinates through the affine transformation matrix, and the performing extrinsic parameter calibration on the vehicle camera through the target coordinates comprise:
performing coordinate transformation on the image coordinates through the affine transformation matrix to obtain target coordinates in the vehicle coordinate system;
connecting the key points according to the target coordinates to obtain connecting lines, and calculating target extrinsic parameters of the vehicle camera through the connecting lines; and
performing the extrinsic parameter calibration on the vehicle camera based on the target extrinsic parameters.

6. The method according to claim 1, wherein after the converting the image coordinates to target coordinates through the affine transformation matrix, and the performing extrinsic parameter calibration on the vehicle camera through the target coordinates, the method further comprises:
mapping the target coordinates through an inverse matrix of the affine transformation matrix to obtain a bird's-eye view of the target coordinates; and
acquiring picture pixels of the bird's-eye view and a current extrinsic parameter calibration region of the vehicle camera, and determining an extrinsic parameter calibration error through the picture pixels and the extrinsic parameter calibration region.

7. The method according to claim 1, wherein the generating a grid through the image coordinates of the key points comprises:
connecting the key points according to the image coordinates by straight line connection or curve fitting to generate the grid corresponding to the preset parking area.

8. The method according to claim 1, wherein the controlling the first line of the grid to be parallel to the second line of the preset parking area specifically comprises:
adjusting the initial extrinsic parameters of the vehicle camera by utilizing a principle that parallel grid lines, which are virtually generated from the ground image and are parallel to the parking area markings, remain parallel after affine transformation of a camera model.

9. The method according to claim 3, wherein the initial position comprises three-dimensional coordinates and an initial orientation of the vehicle camera.

10. The method according to claim 5, wherein the calculating the target extrinsic parameters of the vehicle camera through the connection lines comprises:
calculating the target extrinsic parameters describing a position and an orientation of the vehicle camera in the vehicle coordinate system by aligning the connecting lines with actual boundaries of the preset parking area; wherein the target extrinsic parameters comprise a rotation matrix and the translation vector.

11. The method according to claim 10, wherein the performing the extrinsic parameter calibration on the vehicle camera based on the target extrinsic parameters comprises:
adjusting a mechanical structure or an electronic control unit of the vehicle camera according to the rotation matrix and the translation vector in the target extrinsic parameters, to align the vehicle camera with the preset parking area.

12. The method according to claim 1, further comprising:
after the extrinsic parameter calibration is completed, driving a vehicle on which the vehicle camera is arranged to a parking lot and controlling a vehicle body of the vehicle to be parallel to markings of a parking space;
controlling the vehicle camera to take a picture of the parking space; and
performing perspective projection on the captured picture, and in a case where the generated top-view image presents a rectangle, determining that the extrinsic parameter calibration is successful.

13. An electronic device, comprising a memory, a processor, and a computer program stored on the memory and executable on the processor; wherein the computer program, when executed by the processor, implements an extrinsic parameter calibration method for a vehicle camera, comprising:
acquiring a ground image collected by the vehicle camera, mapping key points of the ground image according to an image coordinate system to obtain image coordinates of the key points in the image coordinate system, and generating a grid through the image coordinates of the key points;
adjusting initial extrinsic parameters of the vehicle camera based on the image coordinates, and determining a translation vector of the vehicle camera; wherein the initial extrinsic parameters of the vehicle camera is adjusted to control a first line of the grid to be substantially parallel to a second line of a preset parking area;
acquiring an intrinsic parameter matrix of the vehicle camera, and Euler angles between a camera coordinate system and a vehicle coordinate system, and generating an affine transformation matrix through the intrinsic parameter matrix, the translation vector, and the Euler angles; and
converting the image coordinates to target coordinates through the affine transformation matrix, and performing extrinsic parameter calibration on the vehicle camera through the target coordinates.

14. The electronic device according to claim 13, wherein the acquiring a ground image collected by the vehicle camera, mapping key points of the ground image according to an image coordinate system to obtain image coordinates of the key points in the image coordinate system, and the generating a grid through the image coordinates of the key points comprise:
controlling the vehicle camera to aim at the preset parking area, and acquiring the ground image within the shooting field of view of the vehicle camera; wherein the ground image comprises key points of the preset parking area;
mapping the key points of the preset parking area according to the image coordinate system through a preset projection matrix to obtain the image coordinates of the key points in the image coordinate system; and
connecting the key points of the preset parking area according to the image coordinates to generate the grid corresponding to the preset parking area.

15. The electronic device according to claim 13, wherein the adjusting initial extrinsic parameters of the vehicle camera based on the image coordinates, and the determining a translation vector of the vehicle camera comprise:
acquiring an initial position of the vehicle camera, and a current angle between the first line of the grid and the second line of the preset parking area;
adjusting the initial extrinsic parameters of the vehicle camera based on the image coordinates to adjust the current angle to an angle value at which the first line of the grid is substantially parallel to the second line of the preset parking area; and
acquiring a current position of the vehicle camera, and determining the translation vector of the vehicle camera through the initial position and the current position.

16. The electronic device according to claim 13, wherein the acquiring an intrinsic parameter matrix of the vehicle camera, and Euler angles between a camera coordinate system and a vehicle coordinate system, and the generating an affine transformation matrix through the intrinsic parameter matrix, the translation vector, and the Euler angles comprise:
acquiring the intrinsic parameter matrix corresponding to camera intrinsic parameters, and the Euler angles between the camera coordinate system and the vehicle coordinate system; wherein the Euler angles comprise a pitch angle, a yaw angle, and a roll angle;
obtaining a rotation matrix from the camera coordinate system to the vehicle coordinate system based on the pitch angle, yaw angle, and roll angle; and
performing calculation through the intrinsic parameter matrix, the translation vector, and the rotation matrix to generate the affine transformation matrix.

17. The electronic device according to claim 13, wherein the converting the image coordinates to target coordinates through the affine transformation matrix, and the performing extrinsic parameter calibration on the vehicle camera through the target coordinates comprise:
performing coordinate transformation on the image coordinates through the affine transformation matrix to obtain target coordinates in the vehicle coordinate system;
connecting the key points according to the target coordinates to obtain connecting lines, and calculating target extrinsic parameters of the vehicle camera through the connecting lines; and
performing the extrinsic parameter calibration on the vehicle camera based on the target extrinsic parameters.

18. The electronic device according to claim 13, wherein after the converting the image coordinates to target coordinates through the affine transformation matrix, and the performing extrinsic parameter calibration on the vehicle camera through the target coordinates, the computer program is further configured to implement:
mapping the target coordinates through an inverse matrix of the affine transformation matrix to obtain a bird's-eye view of the target coordinates; and
acquiring picture pixels of the bird's-eye view and a current extrinsic parameter calibration region of the vehicle camera, and determining an extrinsic parameter calibration error through the picture pixels and the extrinsic parameter calibration region.

19. A non-transitory computer-readable storage medium, storing a computer program; wherein the computer program, when executed by a processor, implements an extrinsic parameter calibration method for a vehicle camera, comprising:
acquiring a ground image collected by the vehicle camera, mapping key points of the ground image according to an image coordinate system to obtain image coordinates of the key points in the image coordinate system, and generating a grid through the image coordinates of the key points;
adjusting initial extrinsic parameters of the vehicle camera based on the image coordinates, and determining a translation vector of the vehicle camera; wherein the initial extrinsic parameters of the vehicle camera is adjusted to control a first line of the grid to be substantially parallel to a second line of a preset parking area;
acquiring an intrinsic parameter matrix of the vehicle camera, and Euler angles between a camera coordinate system and a vehicle coordinate system, and generating an affine transformation matrix through the intrinsic parameter matrix, the translation vector, and the Euler angles; and
converting the image coordinates to target coordinates through the affine transformation matrix, and performing extrinsic parameter calibration on the vehicle camera through the target coordinates.

20. The storage medium according to claim 19, wherein the acquiring a ground image collected by the vehicle camera, mapping key points of the ground image according to an image coordinate system to obtain image coordinates of the key points in the image coordinate system, and the generating a grid through the image coordinates of the key points comprise:
controlling the vehicle camera to aim at the preset parking area, and acquiring the ground image within the shooting field of view of the vehicle camera; wherein the ground image comprises key points of the preset parking area;
mapping the key points of the preset parking area according to the image coordinate system through a preset projection matrix to obtain the image coordinates of the key points in the image coordinate system; and
connecting the key points of the preset parking area according to the image coordinates to generate the grid corresponding to the preset parking area.
